(19) United States
(12) Patent Application Publication
(10) Pub. No.: US 2017/0238104 A1
(43) Pub. Date: Aug. 17, 2017

(54) Cable Backbone For Receiver

(71) Applicant: Knowles Electronics, LLC, Itasca, IL (US)

(72) Inventors: Randall Allen Sanecki, Bensenville, IL (US); Matthew Manley, Crystal Lake, IL (US)

(21) Appl. No.: 15/045,698

(22) Filed: Feb. 17, 2016

(51) Int. Cl. H04R 25/00

(52) U.S. Cl. CPC H04R 25/556; H04R 25/608; H04R 2225/021; H04R 2225/025; H04R 2225/63

(57) ABSTRACT

An audio device is provided, such as a receiver-in-canal hearing aid, which includes an in-the-ear component, a behind-the-ear component, and a cable connecting the in-the-ear component and the behind-the-ear component. The cable includes a reinforcing backbone having a bulbous end portion anchored to one of the in-the-ear component and the behind-the-ear component. The bulbous end portion includes fibers that have been splayed apart which provides larger surface area for adhesively bonding the bulbous end portion to the in-the ear component or the behind-the-ear component. In one form, the reinforcing backbone includes ultra-high molecular weight polyethylene.

### TECHNICAL FIELD

This disclosure relates generally to audio devices and, more particularly, to audio devices having cables that connect receivers of the audio devices to other components of the audio devices.

### BACKGROUND

Various types of audio devices are known that include one or more receivers that convert electrical signals into sound. Among these are receiver in the canal (RIC) hearing aids which have a behind-the-ear component and an in-the-ear component. These two components are electrically attached by a cable. The cable includes a tube containing a plurality of wires (e.g., litz wires).

### BRIEF DESCRIPTION OF THE FIGURES

For a more complete understanding of the disclosure, reference should be made to the following detailed description and accompanying drawings wherein:

FIG. 1 is a view of a hearing aid including a cable connecting a behind-the-ear component and an in-the-ear component in accordance with various embodiments of the present invention;

FIG. 2 is a perspective view of a fiber braid that reinforces the cable of FIG. 1 in accordance with various embodiments of the present invention;

FIG. 3 is a side view of the fiber braid of FIG. 2 located within a tube of the cable in accordance with various embodiments of the present invention;

FIG. 4 is a schematic view of the cable of FIG. 3 with adhesive securing a bulbous end of the fiber braid to a housing in accordance with various embodiments of the present invention;

FIG. 5 is a graph of abrasion resistance and flex life of various materials in accordance with various embodiments of the present invention;

FIG. 6 is a graph of strength retention versus exposure to sunlight of Dyneema and Aramid materials in accordance with various embodiments of the present invention;

FIG. 7 is a graph of strength retention versus exposure to chemicals of varying pH of Dyneema and Aramid materials in accordance with various embodiments of the present invention;

FIG. 8 is a graph of force per linear mass density versus Young's modulus of various materials in accordance with various embodiments of the present invention; and

FIG. 9 is a graph of force per linear mass density versus elongation of a various materials in accordance with various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

In accordance with one aspect of the present disclosure, a cable is provided for connecting components of an audio device. The cable may include a reinforcing backbone made of a material that provides high strength and multiple locations to secure the backbone to one or more components of the audio device.

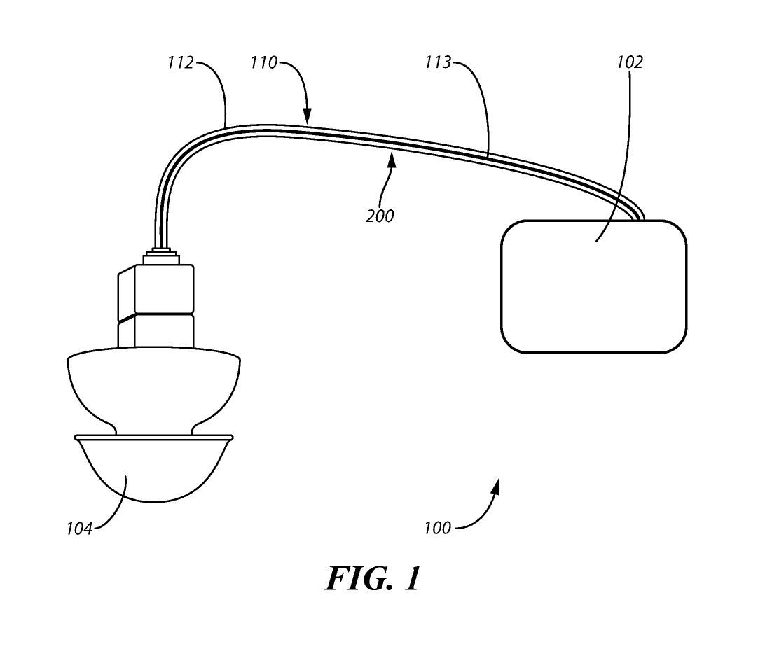

Referring to FIG. 1, an audio device, such as an RIC hearing aid 100, comprises an in-the-ear component 104, a behind-the-ear component 102, and a cable 110. The cable 110 can directly attach the in-the-ear component 104 to the behind-the-ear component 104, or can include a plug on one or both ends to detachably connect to the in-the-ear component 104 and/or the behind-the-ear component 102. The cable 110 includes a tube 112 containing at least one conductive wire 113 (e.g., litz wires) for transmitting electrical signals between the behind-the-ear component 102 and the in-the-ear component 104. The tube 112 can be made of any flexible material, including a clear thermoplastic such as polyether block amide. The cable 110 also includes a reinforcing material or backbone 200 extending through the tube 112. The backbone 200 may be made of woven or braided material. In one form, the backbone 200 includes an ultra-high molecular weight polyethylene (UHMWPE). The backbone 200 may be in the form of a strip, a cable, or a sleeve, for example.

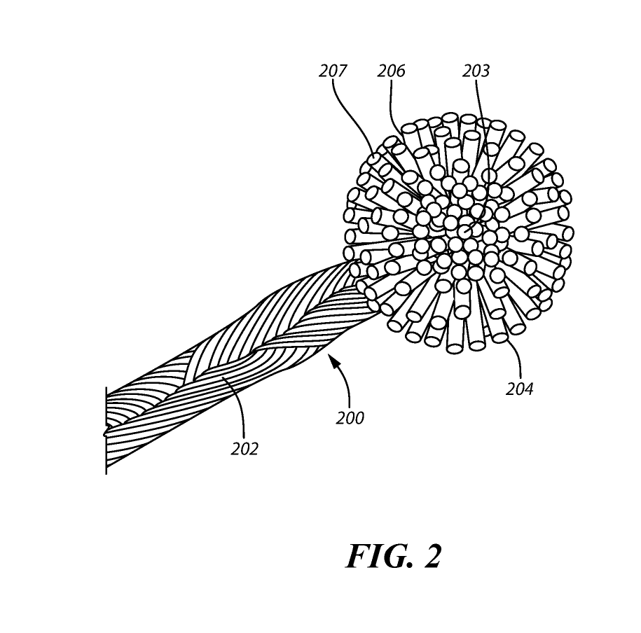

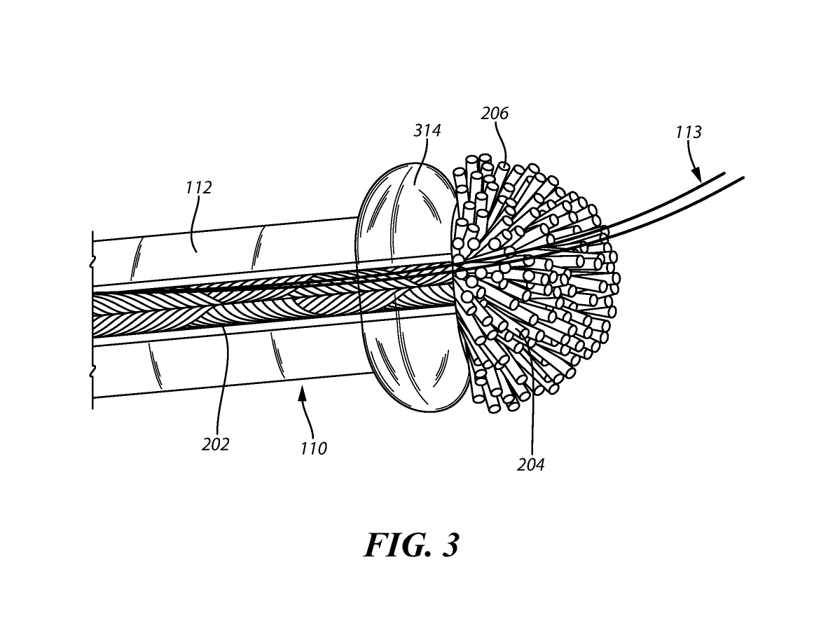

With reference to FIG. 2, the backbone 200 has a braid portion 202 and a bulb portion 204. The braid portion 202 is located within the tube 112, as shown in FIG. 3, and may extend the entire length of the tube 112. The bulb portion 204 protrudes from the end of the tube 112. The tube 112 has a pair of opposite ends and another bulb portion 204 protrudes from the other end of the tube 112. As used herein, the term bulb or bulbous refers to a shape that is rounded in three dimensions and is enlarged relative to an adjacent portion. The bulb portion 204 provides increased surface area to improve bonding with an adhesive 416 used to attach the cable 110 to the in-the-ear component 104 or the behind-the-ear component 102, as discussed in greater detail below.

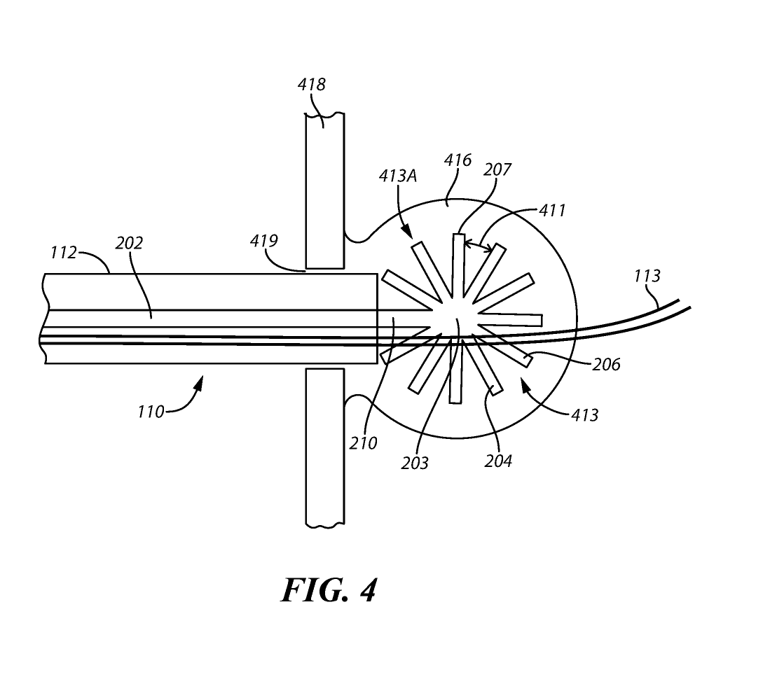

The bulb portion 204 of the backbone 200 may be formed by heating an end of the braid portion 202. When heated, the end of the braid portion 202 unravels and individual fibers 206 within the braid portion 202 splay out and separate from each other. As shown in FIGS. 2 and 4, the fibers 206 extend radially outward from a center 203 of the bulb portion 204 in many directions and positions ends 207 of the fibers 206 such that ends 207 of the fibers 206 form points on a generally spherical shape. Further, substantially all of the fibers 206 are spaced apart from the immediately surrounding fibers 206 which permits adhesive 416 to travel radially inward toward the center 203 along the fibers 206. The adhesive 416 may thereby bond to the radially extending exterior surface and the end 207 of each of the fibers 206.

Either one or both ends of the braid portion 202 can be heated to create bulb portions 204 for improved bonding. As noted above, the backbone 200 may include UHMWPE. The specific thermal properties of UHMWPE are shown in Table 1 below. For example, bulb portions 204 can be formed by heating the end of the braid portion 202 to at least approximately 200° C. for approximately 1 to approximately 5 seconds. The heating causes the fibers 206 to separate from each other in a random pattern. The heating time can vary depending on the size of the braid portion 202 and the size of the bulb portion 204 desired. For example, the end of the braid portion 202 can be heated for a longer period of time to form a larger bulb portion 204.

TABLE 1
Thermal Properties of UHMWPE

| Thermal Property | Value |
|---|---|
| Melting range | 144-152° C. |
| Decomposition temperature | >300° C. |
| Advised lowest temperature | No limit |
| Advised long duration temperature limit | 70° C. |
| Advised short duration temperature limit | 130° C. |
| (non-constrained fiber) | |
| Advised short duration temperature limit | 145° C. |
| (constrained fiber) | |

The bulb portions 204 can further improve the durability of the RIC hearing aid 100 by being used to form a mechanical stop during assembly of the RIC hearing aid 100. For example, one end of the braid portion 202 may first be advanced through a hole 419 in a housing 418 of the behind-the-ear component 102 or the in-the-ear component 104 as shown in FIG. 4. The hole 419 is sized slightly larger than a width of the braid portion 202 to allow the braid portion 202 to extend through the hole 419. If the tube 112 is also to extend through the hole 419, the hole 419 is sized slightly larger than an outer diameter of the tube 112 to permit the tube 112 and the braid portion 202 therein to be advanced through the hole 419. Once the braid portion 202 has been advanced through the hole 419, the end of the braid portion 202 may then be heated to form the bulb portion 204 which is larger than the hole 419 and thus resists the cable 110 from being pulled out of the housing 418 of the behind-the-ear component 102 or the in-the-ear component 104. The bulb portion 204 has a diameter larger than a diameter of the braid portion 202. For example, the bulb portion 204 may have a diameter in the range of approximately 1.5 to approximately 10 times the diameter of the braid portion 202, such as approximately seven times the diameter of the braid portion 202.

Referring to FIG. 3, in some embodiments the tube 112 is formed to include a blunted end 314. For example, the end 314 of the tube 112 may be heated and pressed against a forming die to blunt the end 314 before advancing the braid portion 202 and wires 113 through the tube 112. The end 314 may be blunted after the tube 112 has been advanced through the hole 419. Like the bulb portion 204, the blunted end 314 both increases the surface area for bonding to an adhesive and can be used as a mechanical stop to resist pull-through of the cable 110 from the hole 419.

With reference to FIG. 4, the adhesive 416 has been applied to the bulb portion 204. The adhesive 416 can be any glue, cement, or epoxy suited to bond the bulb portion 204 to the housing 418 of the behind-the-ear component 102 or the in-the-ear component 104. The adhesive 416 bonds the splayed apart fibers 206 of the bulb portion 204 to the housing 418. The wires 113 may extend out of the ball of adhesive 416 as shown in FIG. 4.

Each of the fibers 206 is separated from the immediately surrounding fibers by an angle 411. A majority of the fibers 206 extend obliquely to the immediately surrounding fibers 206. In some forms, more than half, more than 75%, or substantially all of the fibers 206 extend obliquely to the immediately surrounding fibers 206. This arrangement of the fibers 206 positions the ends 207 of the fibers 206 forms a first hemisphere 413 of spaced-apart ends 207 of the fibers 206. As used herein, the term hemisphere refers to half a sphere. It is intended that the term hemisphere with respect to the hemisphere 413 encompasses slight variations in the length of the fibers 206 of the bulb portion 204 which position the spaced-apart ends 207 at slightly different distances from the center 203 of the bulb portion 204. The ends 207 of the fibers 206 may also be positioned to form a partial hemisphere 413A having an annular shape that extends around a connecting portion 210 of the backbone 200. As shown, the bulb portion 204 can also be nearly spherical. The fibers 206 nearest the braid portion 202 are separated by an angle approximately equal to the angle between fibers 411 or any angle less than 180°, such as less than 90°.

With the individual fibers 206 splayed apart as shown in FIG. 4, the adhesive 416 bonds along the exterior surface of each individual fiber 206 and extends radially inward toward the center 203 within the spaces between the fibers 206. If the bulb portion 204 had not been formed, the adhesive 416 would be limited to adhering to the outer surface of the braid portion 202. Thus, the bulb portion 204 drastically increases the surface area for bonding with the adhesive 416 and in doing so reduces the likelihood of the bond failing. In some embodiments, the cable 110 can be welded to the housing 418 of the behind-the-ear component 102 or the in-the-ear component 104 in which case melted plastic of the housing 418 would bond to the bulb portion 204.

In one approach for connecting the backbone 200 to the housing 418, the tube 112 with backbone 200 and the wires 113 is advanced through the hole 419 and the adhesive 416 is applied to the bulb portion 204. The housing 418 is advanced along the braided portion 202 toward the bulb portion 204 until the housing 418 makes contact with the bulb portion 204 and adhesive 416 thereon. This contact causes a portion of the adhesive 416 to transfer onto the housing 418 as shown in FIG. 4. In one approach, additional adhesive is applied directly to the housing 418 once the housing 418 contacts the bulb portion 204. In another approach, the housing 418 is advanced along the tube 112 and against the bulb portion 204. The adhesive 416 is then applied to both the housing 418 and the bulb portion 204 at the same time.

Many companies make UHMWPE fibers, with illustrative examples including DYNEEMA® available through DSM and SPECTRA® available through Honeywell. UHMWPE fibers may provide some advantages over other backbone materials, such as aramid fiber (i.e., KEVLAR® available from DuPont). For example, an end of a backbone of UHMWPE forms a bulb portion 204 when heated, whereas an end of a backbone of aramid would need to be spread manually. UHMWPE also exhibits low capillary action, thus the adhesive 416 remains in place long enough to set. Aramids and other materials with higher capillary action may draw the adhesive 416 away from the surfaces of the housing 418.

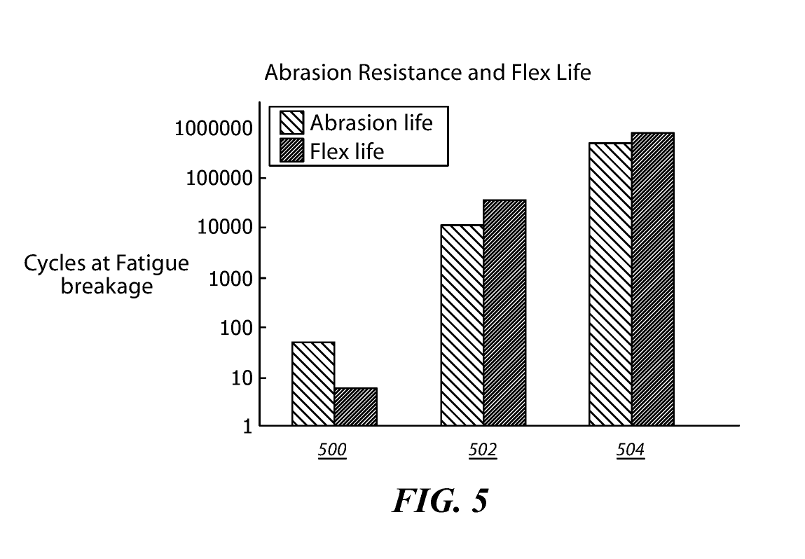

UHMWPE also provides superior strength and fatigue resistance compared to other materials. FIG. 5 is a graph showing the life expectancy of Carbon 500, an Aramid 502, and DYNEEMA® SK60 504 measured in cycles of fatigue. The graph has a logarithmic scale. Both fatigue from abrasion and fatigue from flexing are given. As shown, DYNEEMA® SK60 504 lasts longer than carbon or Aramid (e.g., KEVLAR®) when subjected to abrasion or flexing.

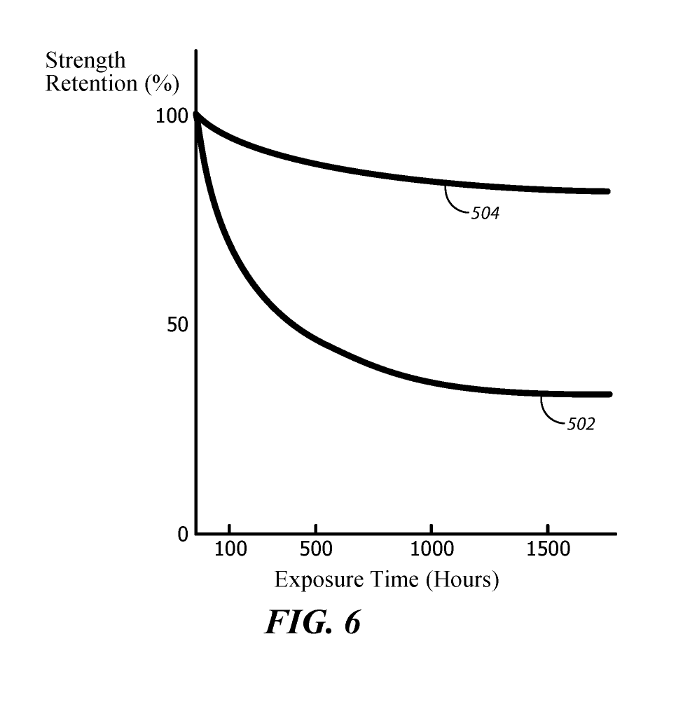

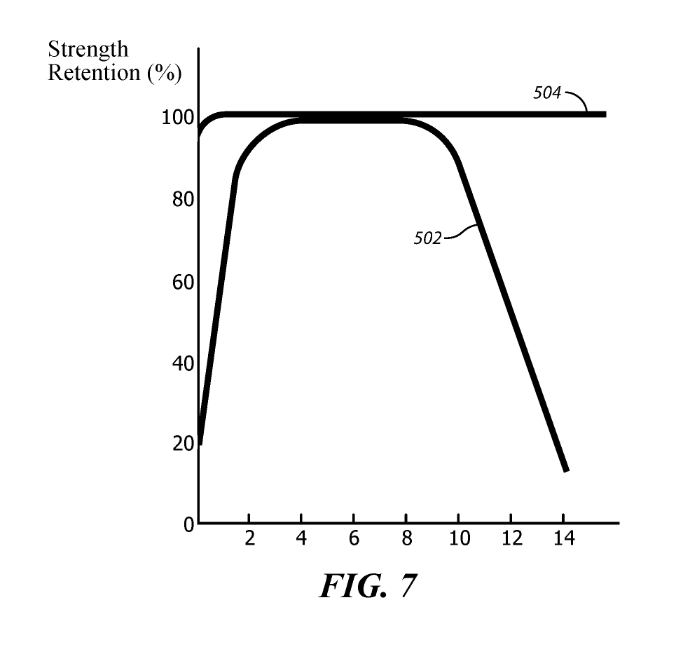

UHMWPE fiber is also known to have high resistance to both light and chemicals. FIG. 6 is a graph showing strength retention of DYNEEMA® SK 60 504 and an Aramid 502 when exposed to daylight without protective coatings. As can be seen, DYNEEMA® SK60 504 retains more than 75% of its strength after 1500 hours of direct sunlight whereas the Aramid 502 dropped below 50% strength in less than 500 hours. FIG. 7 is a graph showing strength retention of DYNEEMA® SK 60 504 and an Aramid 502 when exposed to chemicals of varying pH. DYNEEMA® experiences a very minor drop in strength when exposed to strong acids (near 0 on the pH scale), and retains 100% strength against acids and bases of higher pH. The aramid, however, experiences a large drop off in strength when exposed to either strong acids or strong bases.

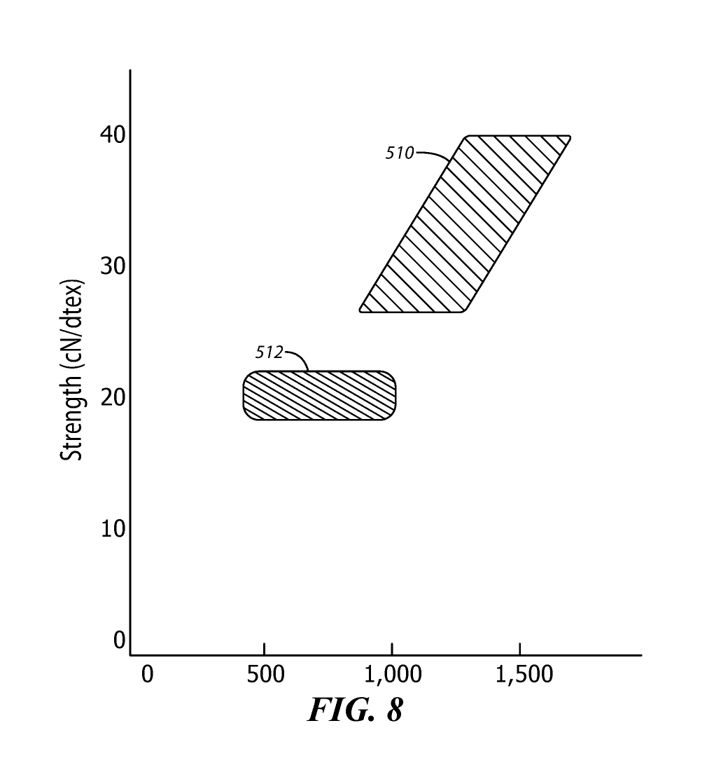

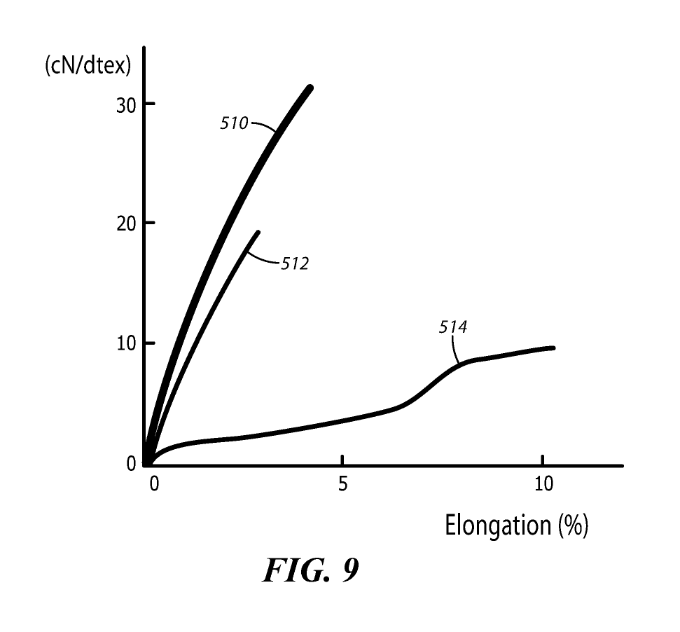

Referring to FIG. 8, DYNEEMA® 510 has a higher specific strength than other common reinforcing materials. The high strength allows the same amount of reinforcement from a smaller cross section of material. This in turn allows the cable 110 to have a smaller diameter for a given strength rating than if it were reinforced with an aramid material. A smaller diameter cable 110 reduces the cost of the tube 112. In FIG. 8, strength (also known as tenacity) is the amount of force required to break a fiber measured in centiNewtons/decitex (cN/dtex). Decitex is the linear mass density of a fiber in grams per 10,000 meters. FIG. 8 also shows the Young's modulus of the materials. DYNEEMA® 510 fibers are less elastic, and thus stretch less than aramid fibers 514. This high Young's modulus is desirable in a cable reinforcing material as stretching of the cable may place stress on the wires and connectors within the hearing aid 100. The elasticity is also shown in FIG. 9. It takes a larger amount of force per linear mass density of fiber to stretch DYNEEMA® 510 compared to Aramid 512 or polyester 514.

It will be appreciated that numerous variations to the above-mentioned approaches are possible. Variations to the above approaches may, for example, include heating to different temperatures and/or for different amount of times, or using unlisted materials to serve the same purpose as the materials listed above.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A cable for an audio device, the cable comprising:
an elongate tube having opposite ends;
at least one wire extending through the tube;
a reinforcing backbone including a plurality of fibers extending through the tube;
an end portion of the reinforcing backbone including ends of the fibers, the end portion being outside of one of the ends of the tube; and
the ends of the fibers forming a spaced apart, hemispherical pattern with gaps between the ends of the fibers for permitting ingress of adhesive between the fibers.

2. The cable of claim 1 wherein the reinforcing backbone includes another end portion outside of the other end of the tube, the other end portion including ends of the fibers forming a spaced apart, hemispherical pattern.

3. The cable of claim 1 wherein the reinforcing backbone includes a connecting portion extending out of the one end of the tube and the ends of the fibers form a spaced apart, partially hemispherical pattern that extends around the connecting portion.

4. The cable of claim 1 wherein the fibers of the reinforcing backbone include ultra-high molecular weight polyethylene fiber.

5. The cable of claim 1 further comprising adhesive secured to and surrounding the ends of the fibers forming the spaced apart, hemispherical pattern.

6. The cable of claim 1 wherein the fibers of the reinforcing backbone are braided.

7. An audio device comprising:
an in-the-ear component;
a behind-the-ear component;
a tube extending between the in-the-ear component and the behind-the-ear component;
at least one wire extending through the tube and electrically connecting the in-the-ear component to the behind-the-ear component;
a reinforcing backbone extending through the tube; and
a bulb portion of the reinforcing backbone outside of the tube and including a plurality of fibers anchored to one of the in-the-ear component and the behind-the-ear component.

8. The audio device of claim 7 wherein the bulb portion includes a center and the fibers extend radially outward from the center and space ends of the fibers apart from each other.

9. The audio device of claim 7 wherein the fibers of the bulb portion have ends in a spaced apart, hemispherical pattern.

10. The audio device of claim 9 wherein the reinforcing backbone includes a connecting portion extending outward from the tube and the fibers of the bulb portion have ends in a spaced apart, semi hemispherical pattern around the connecting portion.

11. The audio device of claim 7 wherein at least 75% of the fibers of the bulb portion extend obliquely to the immediately surrounding fibers.

12. The audio device of claim 11 wherein the reinforcing backbone includes another bulb portion having fibers anchored to the other of the in-the-ear component and the behind-the-ear component.

13. The audio device of claim 11 wherein the fibers of the bulb portion include ultra-high molecular weight polyethylene fiber.

14. The audio device of claim 11 wherein the tube comprises a blunted end anchored to one of the behind-the-ear component and the behind-the-ear component.

15. The audio device of claim 11 wherein the bulb portion is anchored to the one of the in-the-ear component and the behind-the-ear component by an adhesive.

16. A method comprising:
heating a first end portion of a reinforcing backbone to cause fibers of the first end portion to separate into a bulb shape;
applying an adhesive to the bulb-shaped first end portion of the reinforcing backbone; and
anchoring the bulb-shaped first end portion of the reinforcing backbone to a first component.

17. The method of claim 16 further comprising advancing a housing of the component along a tube containing the reinforcing backbone; and
anchoring the bulb-shaped first end portion of the reinforcing backbone to the first component includes anchoring the bulb-shaped first end portion to the housing.

18. The method of claim 16 further comprising:
heating a second end portion of the reinforcing backbone to cause fibers of the second end portion to separate into a bulb shape;
applying an adhesive to the bulb-shaped second end portion of the reinforcing backbone; and
anchoring the bulb-shaped portion second end portion of the reinforcing backbone to a second component.

19. The method of claim 16 wherein the fibers of the reinforcing backbone comprises ultra-high molecular weight polyethylene fibers.

20. The method of claim 16 wherein the first component is one of an in-the-ear component and a behind-the-ear component of a hearing aid.
